(19) United States
(12) Patent Application Publication
(10) Pub. No.: US 2009/0207862 A1
(43) Pub. Date: Aug. 20, 2009

(54) Controlling The Operation Of Modules

(75) Inventor: Derek Underwood, Amherst, NH (US)

Correspondence Address: LERNER GREENBERG STEMER LLP, P O BOX 2480, HOLLYWOOD, FL, 33022-2480, US

(73) Assignee: NOKIA SIEMENS NETWORKS GMBH & CO. KG, München (DE)

(21) Appl. No.: 11/794,765

(22) PCT Filed: Dec. 28, 2005
(86) PCT No.: PCT/EP2005/014079

§ 371 Date: Jul. 3, 2007

Related U.S. Application Data
(60) Provisional application No. 60/641,481, filed on Jan. 5, 2005.

(51) Int. Cl. H04J 3/00; G06F 13/42

(52) U.S. Cl. 370/498; 710/105

(57) ABSTRACT

In a method for controlling the operations of modules that are interconnected through interconnections in which high-speed signals operate at high-bit rates, a low-frequency signal is placed on at least one of the interconnections. From the low-frequency signal operational information on the modules is retrieved.

The present invention relates to a method according the preamble of claim 1 and to a system according the preamble of claim 15.

State-of-the-art computing and telecom backplanes use high-speed interconnections between boards. These interconnections may be directly via a connector or may be via a backplane containing a fabric to interconnect multiple modules in a chassis or shelf.

In standards-based carrier grade communication equipment, it is therefore very important that fabric component and module vendors, as well as system integrators, agree on a common definition of the electrical characteristics and pin mappings for the used fabric technologies.

Requirements of state-of-the-art shelf interconnects are defined in industry specifications so as to allow backplane environments and direct module-to-module interconnections to support a variety of standard and a variety of different proprietary fabric interfaces.

The PICMG 3.0 standard, AdvancedTCA, is an example of an industry standard targeted to the requirements of communications equipments that are next generation and carrier grade. These specifications incorporate the latest trends in high speed interconnect technologies, next generation processors and improved reliability, manageability and serviceability. Other examples in development include the Compact TCA and the Micro TCA.

State-of-the-art shelf interconnects, in next generation communication equipment, are typically based on a star or mesh of high-speed serial signals that may operate at 1 Gigabit per second or higher. Various standards-based options exist for the fabric. For example, PICMG 3.x fabric variants include Gigabit Ethernet, PCI Express, Advanced Switching, and others.

As defined by PICMG 3.0, the base interconnect is a 10/100/1000 BaseTX star backplane interconnection of every module to a pair of hub cards that contain Ethernet switches. Such base interconnect is intended for control such as signaling, switch connection setup and release commands, system operations, administration, provisioning activity, statistics files, standby check-pointing data, system download and backup files, and system boot commands. Being limited to Ethernet, the base interface needs no negotiation between modules and the hubs beyond what is provided in the Ethernet standard for automoding between the 10/100/1000 Mb/s rates.

Unlike the base interconnect, the PICMG defines several alternatives standards for the AdvancedTCA fabric, PICMG 3.1 . . . 3.5. The only common element is the voltage and the current level. The number of signals (between 1 and 4 in each direction in the ATCA fabric), the speed, the framing structure, and the multiplexing structure may vary.

Hence, the AdvancedTCA standard has precisely defined a base level interconnect for control but has left multiple choices for the fabric interconnection. Further, vendors are free to go beyond the range of current standards and define their own framing structure, e.g. the use of TDM between compatible modules, different speed options, and multiplexed signals.

Such fabric flexibility has the obvious drawback that it can limit multi-vendor interoperability and the ability to plug-and-play. This could be alleviated to some extent if there was provision for negotiation.

Systems using mid-plane architectures with rear-mounted external I/O have an additional interoperability challenge in that not only do the front modules need to interconnect but also front modules have to interconnect to rear modules. Developers will therefore typically specify a standard connector type for this purpose but beyond this there may be multiple variations of front and rear module combination that may be possible, for example a rear module with electrical I/O and another with optical I/O working with the same front module.

In order to obtain plug-and-play interoperability, there must be means for declaring the speed and the format of signals.

To declare such signal information, AdvancedTCA provides an IPMI inventory bus and a form of electronic keying. The IPMI inventory bus is a low-speed bus that connects every module and it is powered separately from the module functional components.

The IPMI inventory bus and the e-keying mechanism of AdvancedTCA are intended to provide information on the module type to the shelf management system and system controller to assure high-level compatibility before the board is powered up.

A fabric type declaration mechanism based on the IPMI inventory bus has the drawback that it only allows modules to declare their capabilities to the shelf manager within the constraints of the defined standards. This allows the shelf manager to read the modules type, revision number, and serial number to make a decision on whether to power the module up. If the shelf manager sees that two modules are compatible it will power them up and the system can operate.

However, through the IPMI inventory bus, there is no negotiation. For example, one module cannot declare a capability to support multiple standards and let the connecting module to make the exact choice of which standard to use.

Moreover, the use of the IPMI inventory bus does not provide full detail on the fabric interface. For example, the format and speed of the signal may be declared over the IPMI inventory bus only within the constraints of what has been defined by the standards. Formats and speeds not defined in the standards cannot be declared.

As seen, the inventory bus method relies on “approval” from a central shelf manager. Specific interface types, structures, or capabilities that pairs of modules may wish to use between each other cannot generally be inventoried and so can only be negotiated through the system controller.

Another major drawback of such prior art method is that it is not possible for a module to declare multiple formats, i.e. a module may need to declare one interface format and speed when communicating to a first additional module and another format and speed when interfacing to a second additional module. Such multiple-format fabric use can be very advantageous in a mesh interconnect.

For example, some media processing architectures may require that TDM interface modules connect to DSP modules using a TDM format, while, such DSP modules may also need to connect to IP interface modules using an Ethernet format. A mesh interconnect allows the use of both formats but in AdvancedTCA only one format can be declared over the IPMI inventory bus.

One method of providing negotiation flexibility could be to use the Ethernet base interface. However, in the PICMG 3.0 standard, the base interconnect is not used for inventory, nor for declaring or negotiating the use of the fabric.

Therefore such a method using the base interconnect would require a new protocol to exchange fabric negotiation messages.

One disadvantage of exchanging capability declaration and negotiation information via a centralized module is that the exchange may be constrained to a protocol and options that the central component understands. While there could be user-definable fields, there is still the need to define an addressing mechanism by which the modules can exchange these messages with each other.

Another disadvantage is that the central module has to be operational before the messages can be exchanged thereby serializing start-up and increasing the time it takes for a system to be fully operational upon boot up.

Still another disadvantage of a centralized method is that rear modules in systems using mid-plane architectures with rear-mounted external I/O would require a control or inventory connection with the central module when otherwise they would only need to connect to the front module.

Another method is to provide additional separate physical interconnections between modules and backplanes. Such additional interconnects may be dedicated copper traces or optical channels. However, such method, for high-speed interconnects, is costly and wasteful when any extra connectors would anyway want to be used to increase high-speed interconnect capacity.

It is therefore the aim of the present invention to overcome the above mentioned drawbacks, in particular by providing a method that allows operational information exchange on modules without requiring additional dedicated interconnects or without making use of a centralized module.

The aforementioned aim is achieved by a method defined by the steps of claim 1 and by a system defined by the features of claim 15.

The low-frequency signal LS1 according to the present invention may be utilized in any computing and telecom shelf systems using high-speed interconnections.

Upon module power-up, the high-bit-rate signals of the fabrics may remain off while the low-frequency signal according to the present invention may be used to provide operational information on modules.

Embodiments of the present invention, having certain advantages, are given in the dependent claims.

The invention will now be described in preferred but not exclusive embodiments with reference to the accompanying drawing, wherein:

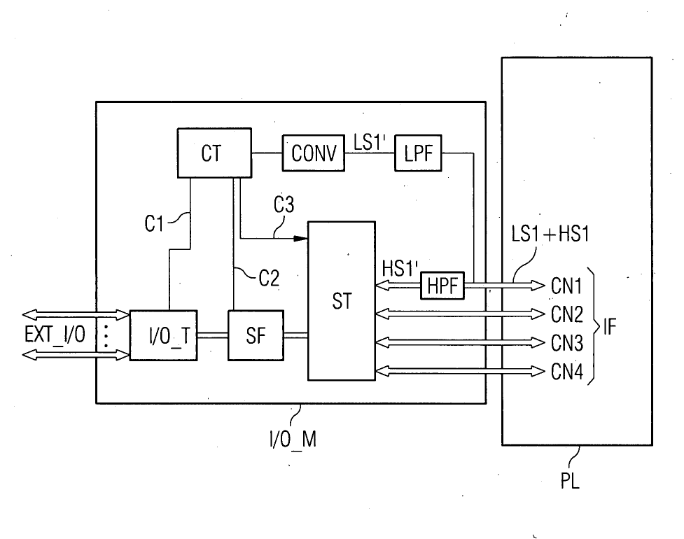

FIG. 1 a block diagram of a circuit for controlling a module interconnection to a backplane in an example embodiment according to the present invention.

FIG. 1 shows a block diagram in which a module or board I/O_M, interfaces to external data, through external data path EXT_I/O, and to a backplane or midplane PL through signal interconnections CN1, . . . , CN4. The module I/O_M is interconnected to a backplane or to a midplane PL. In a further embodiment of the present invention, the module I/O_M, instead of being connected to other modules via a backplane PL, may be interconnected to another module directly via a direct module-to-module connector or via a cable.

EXT_I/O datapath may carry, for example, Gigabit Ethernet or SONET/SDH data such as OC3/STM1 or OC12/STM4 or higher rates. External datapath EXT_I/O may be terminated at I/O a termination module I/O_T. The external datapath EXT_I/O may include one or multiple physical connections. Typically, external datapath EXT_I/O carries redundant signals.

The I/O termination module I/O_T checks the quality of the signal carried by external datapath EXT_I/O and sends, according to the results of the quality check, the relevant I/O alarms and control information to a controller module CT via a termination control signal C1.

The controller CT sends a switch control signal C2 for controlling a switching function module SF so that the relevant signals are passed to a high-speed signal transceiver ST. The switching function SF may be a time-slot interchanger TSI in TDM systems or an Ethernet switching module in packet-based systems.

The controller module CT also enables and disables the high-speed signal transceiver ST via a controlling signal C3. Until the fabric capability negotiation with the partner module is complete, the high-speed signal is expected to be disabled although this is not essential.

A module interconnection interface IF between the backplane PL and the module I/O_M may include any number of connections CN1, . . . , CNn. In an example embodiment of the present invention based on AdvancedTCA, an interconnection CN1, . . . , CN4 may consist of 4 channels of both transmit and receive signals for each direction of transmission, giving a total of eight signals. The skilled in the art easily understands that fabric interfaces IF of different modules may have a different number of connections CN1 . . . CN4 and may have connections CN1, . . . , CN4 that are bi-directional or unidirectional.

In general, the fabric interconnections CN1, . . . , CN4 may be made out of copper or out of optical material and may be any number of parallel interconnections CN1, . . . , CN4.

According to the present invention, a low-frequency fabric signal is placed on one or more of the high-speed fabric interconnections CN1, . . . , CN4.

For example, on the embodiment of FIG. 1, a low frequency signal LS1 is placed on a composite high-speed interconnection CN1.

The fabric CN1 is a composite interconnect since it includes a composite signal having a low-frequency signal LS1 and a high-speed signal LH1 that operates at the high bit-rates of the module interconnection CN1, . . . , CN4.

By filtering the composite fabric signal with a low-pass filter LPF, a filtered low-frequency signal LS1′ may be obtained. By filtering the composite fabric signal with a high-pass filter HPF, a filtered high-speed signal HS1′ may be obtained. The high-pass filter HPF may be constituted by a simple capacitive coupling. Where the fabric interconnections CN1, . . . , CN4 are in the form of differential pairs, the low pass filter LPF is placed in each of the wires of the differential pair. Similarly, the high-pass filter HPF is placed in each of the wires of the differential pair.

In a further embodiment of the present invention, the transceiver ST may operate directly on the composite connection CN1 and may include itself filtering means to extract the low-frequency signal LS1 and the high-speed signal HS1 from the composite signal.

As exemplified by the PICMG 3.× fabrics, state-of-the-art interconnections between boards I/O_M and backplanes PL are nowadays operating with signals HS1 at very high-speeds. In particular, high-speed backplanes PL based on serial interconnects operate at speeds of 1 Gb/s and higher in packet-based systems and at bit-rates of 150 Mb/s and higher in TDM systems.

The frequency band of the low-frequency signal LS1 may be selected in order to avoid interference problems with the high-speed signal HS1. TDM and packet-based systems typically can guarantee a minimum density of ‘1’s and ‘0’s, e.g. from the framing signal, so that the low-end of the frequency spectrum may be reused, according to the present invention, for placing a low-frequency signal LS1 that may be used for several different purposes. The low-frequency signal LS1 and high-speed signal HS1 may be carried as a frequency division multiplex. Conveniently, the low-frequency signal LS1 may be placed underneath the band used by the high-speed signal HS1.

The low-frequency signal LS1 is processed at the controller CT after having been appropriately converted by an A/D and D/A converter CONV.

The worst case is represented by a TDM interconnect carrying a payload of all 0s contained within some framing on an 8 kHz basis. Gigabit per second and higher-speed packet interconnects guarantee higher is and 0s density and therefore allows a faster low-speed signal.

However, with proper filtering between channels, even in the above mentioned worst case, problems due to interferences may be avoided and an 8 kHz minimum 1s and 0s density allows the use of a low-frequency channel up to 3.4 kHz.

Given that 8 kHz represents the minimum point in the spectrum used by a high-speed TDM signal (in a packet signal it is higher), in a further embodiment of the present invention the converter CONV may be replaced by an analogue telephony modem to encode and decode the low-frequency signal LS1 so that the upper bound of its frequency spectrum does not exceed 3.4 kHz and, conveniently, there is insignificant energy at 8 kHz to avoid interference problems with the framing of the high-speed signal HS1. Modem options may range all the way up to the 33.6 kb/s rate of ITU-T V.34 or the 56 kb/s rate of ITU-T V.90.

In a further embodiment of the present invention, the frequency band of the low-frequency signal LS1, which may be placed below or above 8 KHz, may also be negotiated through handshaking signals exchanged during the start-up of the low-frequency signal LS1. This may use a 2-stage start up of low frequency signal LS1, e.g. initially using a ITU-T V.21 signal to negotiate the band and modulation for the ongoing low-frequency signal LS1.

Nowadays modems use handshaking negotiations to mutually agree on which standard to use: typically modem handshaking involves a low-bit-rate signal exchanged (e.g. 300 b/s of ITU-T V.21) before the high-speed modem (e.g. ITU-T V.32, ITU-T V.34, ITU-T V.90) starts to train.

Hence, the handshaking mechanism of modems is applicable in order to change the value of the low-frequency band of the low-frequency signal LS1 or in order to agree on the use of a particular low-frequency signal protocol or speed.

Advantageously, given the widespread availability of modem chips with handshaking functionalities, the cost is low. However, modem handshaking may introduce the cost of increased delay in setup. Preferably, in order to avoid delays setup, a further embodiment of the present invention may be provided with pre-agreed modem standard.

In the illustrated embodiment of FIG. 1, only composite connection CN1 may carry a composite signal having both a low-frequency signal LS1 and high-speed signal HS1; and high-speed signals interconnections CN2, CN3, CN4 may carry only high-speed signals. Other embodiments of the present invention, any or every one of the interconnections CN1, . . . , CN4 may carry a composite signals. Accordingly, band-pass filters LPF and HPF may be provided for any or every one of the composite connections provided in the interconnection CN1, . . . , CN4.

Various telecom and computing systems using high-speed fabrics benefit from the low frequency channel according to the present invention. In particular, systems with interconnect limitations such for example MicroTCA, CompactTCA and compact military systems, benefit from the facts of having, according to the present invention, a low-frequency channel LS1 to be used for operational information without the need of a costly dedicated interconnect.

In fact, as modules and cards I/O_M become smaller the ability to include separate signals for inventory becomes increasingly costly.

Conveniently, according the present invention, the low-frequency signal LS1 may provide a variety of operational information on the system while avoiding dedicated additional interconnections and while avoiding the use of centralized modules.

A first purpose of the provided operational information may be to allow the exchange of capability negotiation data between modules I/O_M, such as plug-and-play declaration. Using capability negotiations, after a module I/O_M is first powered up, modules I/O_M are able to discover their neighbour modules and to set the fabric to the appropriate mode (e.g. format and rate). This capability negotiation via the low-frequency channel LS1, according to the present invention, may occur even when the high-speed signals HS1 are still inactive.

Features of the present invention advantageously allow direct interconnection negotiations between modules.

Capability negotiation involves an offer and response. For example, one module I/O_M makes an offer to an adjacent module on how it proposes to use the eight unidirectional signals of the fabric CN1, . . . , CN4 in each of the two directions of transmission. Specifically, it may propose which of the eight fabric signals are to transmit and which are to receive (although a default may already exist as in PICMG 3.0, for example) and it may propose a format and a speed for each of the fabric signals. The recipient may accept the offer or may make an alternative proposal, e.g. only to use 2 of the 4 interconnections CN1, . . . , CN4 in each direction, or to operate at a lower speed. Preferably, it may also counter propose with a completely different use for the fabric. In case there is no compatibility between transmitter and recipient, then the offer or counter offer may be rejected and such pair of modules I/O_M may not interface to each other over direct fabric connection.

In a plug-and-play operation, declarable options may include the number of interconnect signals in the transmit channel (e.g. 0-8), the number of interconnect signals in receive channel (e.g. 0-8), the transmit speed, the receive speed, and the framing format such as TDM, Ethernet, HDLC, Advanced Switching. In case of TDM systems, SONET/SDH or a custom framing format, further options may also be declared during the capability negotiation.

Therefore, advantageously, plug-and-play can be negotiated between every pair of modules I/O_M interconnected via the fabric independently of every other module pair and a module carries out the above negotiation for every module it connects to.

Moreover, plug-and-play negotiation extensions can be bilaterally agreed between module vendors. In addition, plug-and-play negotiation criteria can be greatly extended, e.g. from switching transmission direction to describing the framing structure.

A further advantage is that plug-and-play negotiation criteria can be made dynamic, e.g. capacity can be altered as a result of partial failures or the addition of pluggable mezzanine modules such as Advanced Mezzanine Cards.

A further advantage is that compatible modules may negotiate their own high-speed interface outside the constraints and knowledge of a centralized module such as, for example, a shelf manager.

A second purpose of the provided operation information according to the present invention is to provide operations support of high-speed signals by allowing ongoing operation communication, such as control and OA&M.

Conveniently, an ongoing operation communication channel may be activated on the low-frequency signal after the high-speed signal HS1 is powered up. The low-frequency channel LS1 may carry status and performance or telemetry information on the high-speed signal HS1.

For example, with an OC3/STM1 interface, the high-speed channel HS1 may carry the clean payload while the low-frequency signal LS1 could carry performance information on the optical signal and noise level measured on the received external interface.

Interface states and performance data reported via this operations channel may include received SONET signal integrity (e.g. LOS, LOF, AIS), received SONET signal performance (e.g. ES, SES, CV) and received fabric high-speed signal integrity.

Therefore, advantageously, telemetry or other status information may be carried describing the principal signal (e.g. integrity and performance of a received SONET signal) without exchanging information via the base interface and the system manager.

A further advantage is that information can be transferred concerning the integrity of the signal received on the high-speed interface from the partner board.

A further advantage is that the high-speed signal HS1 may be relied upon even when centralized control and inventory management are down.

### LIST OF REFERENCE SIGNS

C1,C2,C3 control signals
CONV A/D and D/A converter
CN1 . . . 4 interconnection, fabric, module interconnection, high-speed fabric interconnection, connections, interconnect
CT controller, controller module
EXT_I/O external datapath
HPF high-pass filter
HS1 high-speed signal
HS1′ filtered high-speed signal
I/O_M module, card, board
I/O_T I/O terminator, I/O terminator module
IF interconnection interface, fabric interface
LPF low-pass filter
LS1 low-frequency signal, low-frequency channel
LS1′ filtered low-frequency signal
PL backplane, midplane
SF switching function, switching function module
ST high-speed signal transceiver, high-speed signal transceiver module

### LIST OF ACRONYMS

A/D analogue to digital
AIS alarm indication signal
BaseTX Ethernet interface defined by IEEE 802.3
CV code violations
D/A digital to analogue
DSP digital signal processor
ES errored seconds
HDLC high-level data link control
IPMI intelligent platform management interface
LOF loss of frame
LOS loss of sync
OA&M operations, administration and management
OC3/12 Optical Carrier(3=155 Mb/s; 12=622 Mb/s)
STM1/STM4 Synchronous Transport Module (1=155 Mb/s; 4=622 Mb/s)
SES severely errored seconds
TDM time division multiplexing
TSI time slot interchange

### LIST OF CITED INDUSTRY SPECIFICATIONS AND STANDARDS

AdvancedTCA
   Advanced Telecom Computing Architecture
Compact TCA
   Compact Telecom Computing Architecture
MicroTCA
   Micro Telecom Computing Architecture
PICMG 3.x
   PCI Industrial Computer Manufacture Group, 3.x family
ITU-T V.21
   300 bits per second duplex modem standardized for use in the general switched telephone network
ITU-T V.32
   A family of 2-wire, duplex modems operating at data signalling rates of up to 9600 bit/s for use on the general switched telephone network and on leased telephone-type circuits
ITU-T V.34

A modem operating at data signalling rates of up to 33,600 bit/s for use on the general switched telephone network and on leased point-to-point 2-wire telephone-type circuits
ITU-T V.90
   A digital modem and analogue modem pair for use on the Public Switched Telephone Network (PSTN) at data signalling rates of up to 56,000 bit/s downstream and up to 33,600 bit/s upstream

1. A method for controlling operations of modules, said modules being interconnected through interconnections in which high-speed signals operate at high-bit rates, the method
comprising:
a) placing a low-frequency signal on at least one of said interconnections; and
b) retrieving, from said low-frequency signal, operational information on said modules.

2. The method according to claim 1,
wherein said interconnections are through one of a backplane and a midplane.

3. The method according to claim 1,
wherein said interconnections are through one of a direct module-to-module connector and cable.

4. The method according to claim 1, wherein high-speed signals for TDM systems operate at bit-rates of at least 150 Mb/s, and high-speed signals for packet based systems operate at bit-rates of at least 1 Gb/s.

5. The method according to claim 1, further comprising the step of:
placing said low-frequency signal in a frequency-band below the frequency band of said high-speed signal.

6. The method according to claim 5, further comprising the step of:
placing said low-frequency signal in a frequency-band below 8 kHz.

7. The method according to claim 1, further comprising the step of:
negotiating via handshaking at least one feature of said low-frequency signal; wherein said at least one feature is selected from the group consisting of:
frequency band;
protocol; and
bit-rate.

8. The method according to claim 1, wherein said steps a) and b) are performed by a modem.

9. The method according to claim 1, further comprising the step of:
negotiating interconnection capability between modules by using said operational information.

10. The method according to claim 9, further comprising the step of:
selecting at least one of said interconnection capability from the group consisting of:
number of parallel interconnections;
interconnection speed;
switching transmission direction; and
framing structure.

11. The method according to claim 9, wherein said step of negotiating interconnection capability includes:
a first side of the interconnection interface offering its supported options,
a second side of interconnection interface responding to said offering either by making a selection from said supported options or by making a counter offer, and
said first side, either updating its configuration with said selection or responding to said counter offering as though it was the second side.

12. The method according to claim 9, wherein:
said high bit-rate signal is inactive until said negotiating step is completed.

13. The method according to claim 1, further comprising the step of:
using said operational information for control or OA&M communications on said modules.

14. The method according to claim 1, wherein said modules interconnections adhere to the Advanced TCA PCMG 3.x industry standard.

15. A system for controlling the operations of modules, said modules being interconnected through interconnections in which high-speed signals operate at high-bit rates;
comprising:
means for placing a low-frequency signal on at least one of said interconnections; and
means for retrieving, from said low-frequency signal, operational information on said modules.
